(19) United States
(12) Patent Application Publication
(10) Pub. No.: US 2010/0011258 A1
(43) Pub. Date: Jan. 14, 2010

(54) Coordinating the Execution of System and Database Scripts in a Database Server

(75) Inventors: Erwin Hom, Foster City, CA (US); Jonathan Thatcher, Mountain View, CA (US); Mark Davidson, Scotts Valley, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/172,188

(22) Filed: Jul. 11, 2008

(51) Int. Cl. G06F 11/07; G06F 17/30; G06F 9/46; G06F 11/00

(52) U.S. Cl. 714/49; 707/200; 718/101; 714/55; 714/E11.003; 714/E11.025; 707/E17.005

(57) ABSTRACT

An administrator can specify a script sequence including one or more system scripts and database scripts. A graphical user interface is provided to allow the administrator to specify an execution order of individual scripts in the script sequence and a timeout interval for when the script sequence will complete. Once the script sequence is specified, the script sequence can be run without further intervention by the administrator.

### TECHNICAL FIELD

This subject matter is generally related to database management.

### BACKGROUND

A database is a named collection of database objects (e.g., tables, functions). A database server allows a large number of concurrent users to access a database. One aspect of database server administration is scripting. A script is one or more instructions (script steps) that an administrator defines to automate repetitive or difficult tasks. Some database applications include script managers that allow users to develop scripts for performing various tasks on database objects. These scripts can be run by a database engine of the database server and/or by a host operating system (“OS”).

One example of a database server is FileMaker® Server 9, developed by FileMaker, Inc. (Santa Clara, Calif.). An administrator can install FileMaker Server 9 software on a dedicated computer and upload FileMaker Pro databases to the server. Multiple concurrent users can instantly access the uploaded databases at any time, schedule automated backups, find information, etc.

FileMaker Pro 9 allows a database developer to create scripts. It provides graphical user interfaces that allow an end-user to run a script by clicking a button associated with the script, choosing a menu command associated with the script, calling the script from another script or a plug-in, or running the script when a database file opens or closes.

After a database is created, it can be hosted on FileMaker Server to be shared.

### SUMMARY

An administrator can specify a script sequence including one or more system scripts and a database script. A graphical user interface is provided to allow the administrator to specify the individual scripts in the script sequence and the maximum time allowed for the script sequence to complete. Once the script sequence is specified, the script sequence can be run without further intervention by the administrator.

### DESCRIPTION OF DRAWINGS

FIG. 1 illustrates an example pane of a schedule assistant for selecting a script type for the administrative task to be scheduled on the database server.

FIG. 2 illustrates an example pane of a schedule assistant for adding script sequence parameters.

FIGS. 3A and 3B are block diagrams of an example script management system implemented on a server computer.

FIG. 4 is a flow diagram of an example process for script management that allows administrators to specify the execution order of database scripts and system scripts.

FIGS. 5 and 6 are sequence diagrams illustrating interaction between a schedule manager and a system script launcher.

FIGS. 7 and 8 are sequence diagrams illustrating interaction between a schedule manager and database engine manager.

FIG. 9 is a sequence diagram illustrating interaction between a schedule manager, a system script launcher and a database engine manager.

### DETAILED DESCRIPTION

### Example Schedule Assistant

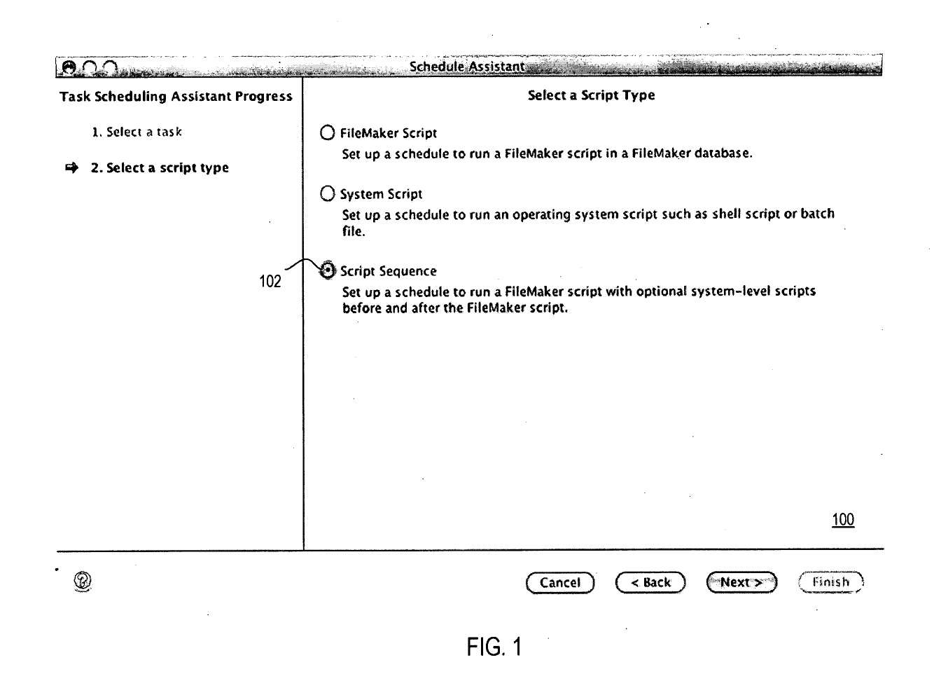

FIG. 1 illustrates an example pane 100 of a schedule assistant for scheduling administrative tasks for a database server. The schedule assistant allows an administrator to schedule administrative tasks for a database server. In some implementations, an administrator can select a script type option from a user interface of the schedule assistant to trigger a presentation of the pane 100. In this example, the administrator can select one of three script types: a database script type, a system script type and a script sequence type 102.

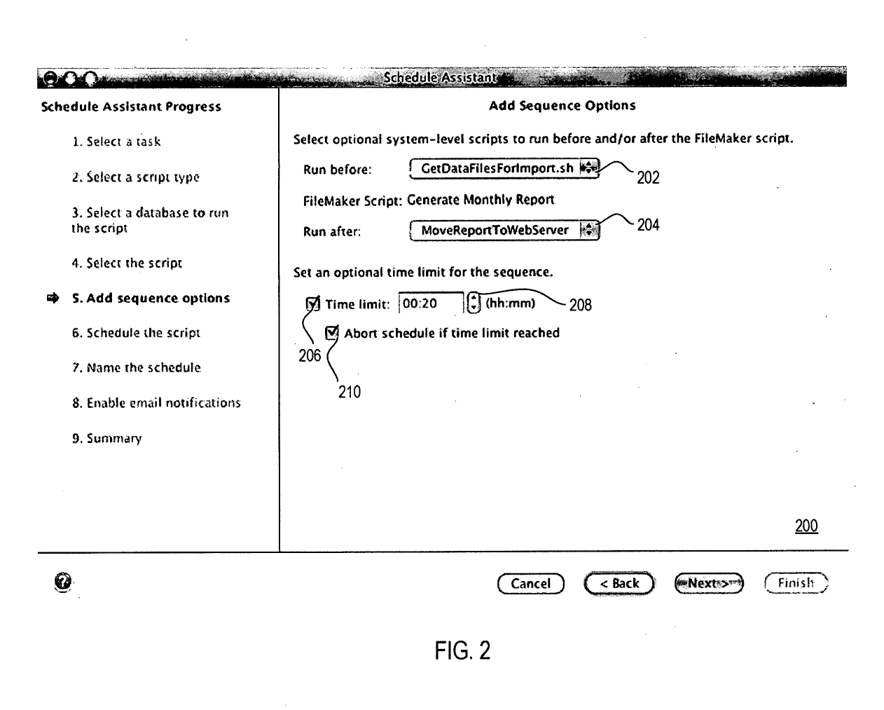

The database script type (e.g., a FileMaker script) allows the administrator to set up a schedule to run a database script in a database. The system script type allows the administrator to set up a schedule to run an system script (e.g., a shell script or batch file). The script sequence type 102 allows the administrator to set up a schedule to run a database script with an optional one or more system scripts to run before and/or after the database script. In the example shown, the administrator has selected the script sequence type 102 by clicking its radio button, and then clicked a “Next” button to enter a user interface for adding script sequence parameters, as described in reference to FIG. 2.

FIG. 2 illustrates an example pane 200 of a schedule assistant for adding script sequence parameters. In some implementations, the pane 200 can include a first combo box 202 for allowing an administrator to specify a first system script to run before a database script runs. In the example, shown a shell script called GetDataFilesForImport.sh is specified. This system script gets files for import into a database script called Generate Monthly Report.

The pane 200 also includes a second combo box 204 for allowing the administrator to specify a second system script to run after the database script runs. In the example shown, a system script called MoveReportToWebServer is specified. After the database script generates the monthly report, the system script MoveReportToWebServer moves the monthly report to a Web server. The static text between the combo boxes 202 and 204 (e.g., “FileMaker Script: Generate Monthly Report”) visually indicates the order of the script sequence. The script sequence is: 1) get files for import; 2) generate a monthly report using imported files; and 3) move the monthly report to a web server. Generally, the combo boxes 202 and 204 can be populated with system scripts from a script directory on the database server.

If the “Time Limit” check box 206 is checked, the timeout field 208 will be enabled to allow the administrator to enter a timeout interval. The script sequence is expected to complete within the time limit specified in the timeout filed 208. In the example shown, a time limit of 20 minutes is specified in the timeout field 208. Thus, the script sequence is to complete within a 20 minutes. When the time limit is reached, a warning can be logged or other action taken. If the checkbox 210 is checked, the schedule will be aborted if the time limit specified in the timeout field 208 is reached.

Although the pane 200 includes two system scripts and one database script, it should be understood that any number of system scripts and database scripts can be specified in any desired order, and that the pane 200 can be modified to allow such specifications.

### System Overview

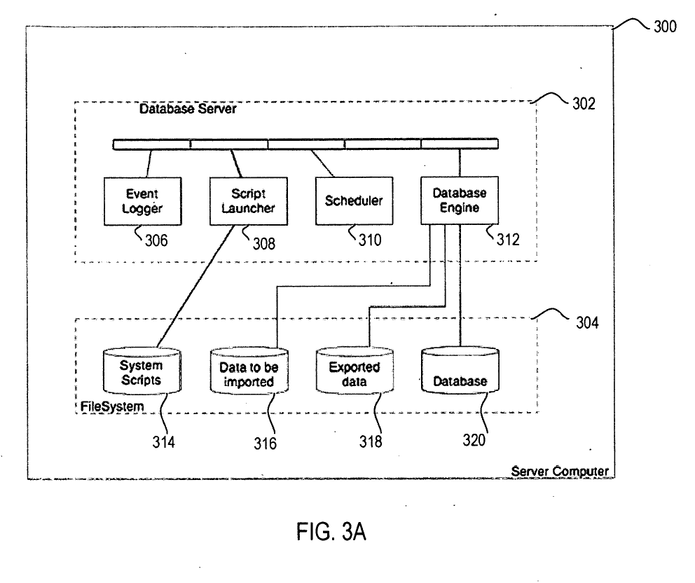

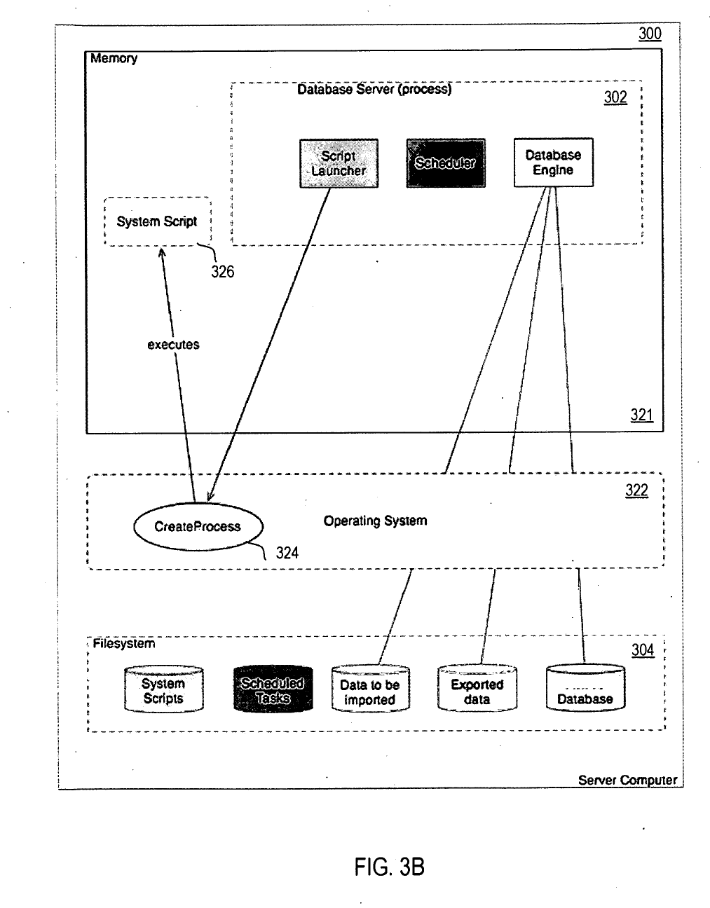

FIG. 3A is a block diagram of an example script management system implemented on a server computer 300. In some implementations, a server computer 300 can include a database server 302 and a file system 304. The database server 302 can include an event logger 306, a system script launcher 308, a scheduler 310 and a database engine 312. The file system 304 can include a system script directory 314, import data 316, export data 318 and one or more databases 320.

Referring to FIGS. 3A and 3B together, the database server 302 can be a process that resides in memory 321 of the server computer 300. The script launcher 308 can be an embedded component of the database server 302. The script launcher 308 is responsible for calling the OS 322 to create a process 324 for a system script 326 to run. The script launcher 308 is also responsible for notifying the scheduler 310 when the system script 326 has exited. Resulting OS errors can be mapped to respective database server errors. System scripts can be stored in the system script directory 314 of the server computer 300.

The scheduler 310 can be an embedded component of the database server 302. The scheduler 310 is responsible for scheduling administrative tasks such as verification of database(s) 320 and backups, calling respective components to run database scripts and system scripts, logging script results, and scheduling the next run. In some implementations, the scheduler 310 can include a scheduler assistant application for presenting the panes 100, 200, described in reference to FIGS. 1 and 2.

The database engine 312 executes database scripts. For example, the database engine 312 can execute a script for importing data 316 and a script for exporting data 318. The database engine 312 also performs operations on the one or more databases 320 (e.g., accessing and storing data). The event logger 306 can log warnings and other events or messages that can be used by the administrator to manage the database server 302.

### Example Script Management Process

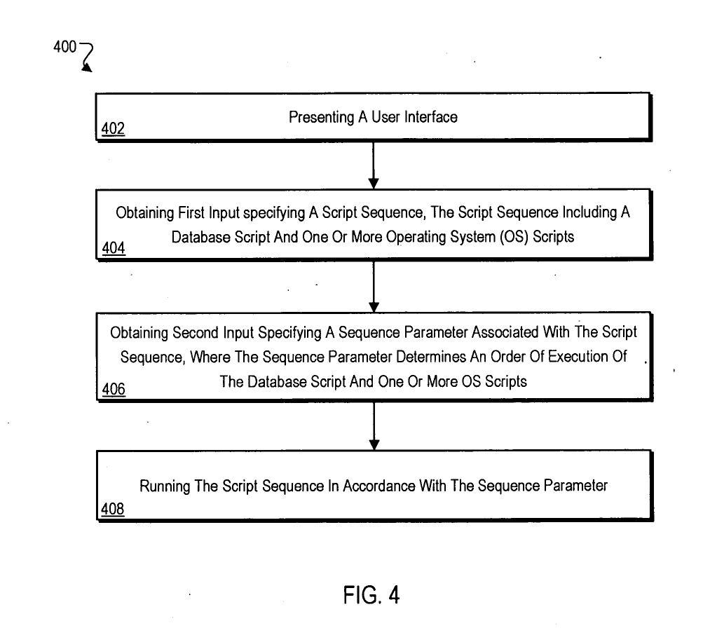

FIG. 4 is a flow diagram of an example process 400 for script management that allows administrators to specify the execution order of database scripts and system scripts. In some implementations, the process 400 begins when an administrator launches a scheduler assistant. The scheduler assistant presents a graphical user interface (402). An example user interface is pane 100. A first input is obtained specifying a script sequence type. The script sequence type can include a database script and one or more system scripts (404).

A second input is obtained specifying one or more sequence parameters associated with the specified script sequence type. In some implementations, a sequence parameter determines an execution order of the database script and the one or more system scripts (406). For example, an administrator can specify that a system script run before and/or after a database script, as described in reference to FIG. 2. The script sequence is run in accordance with the sequence parameter (408).

### Example Sequence Diagrams

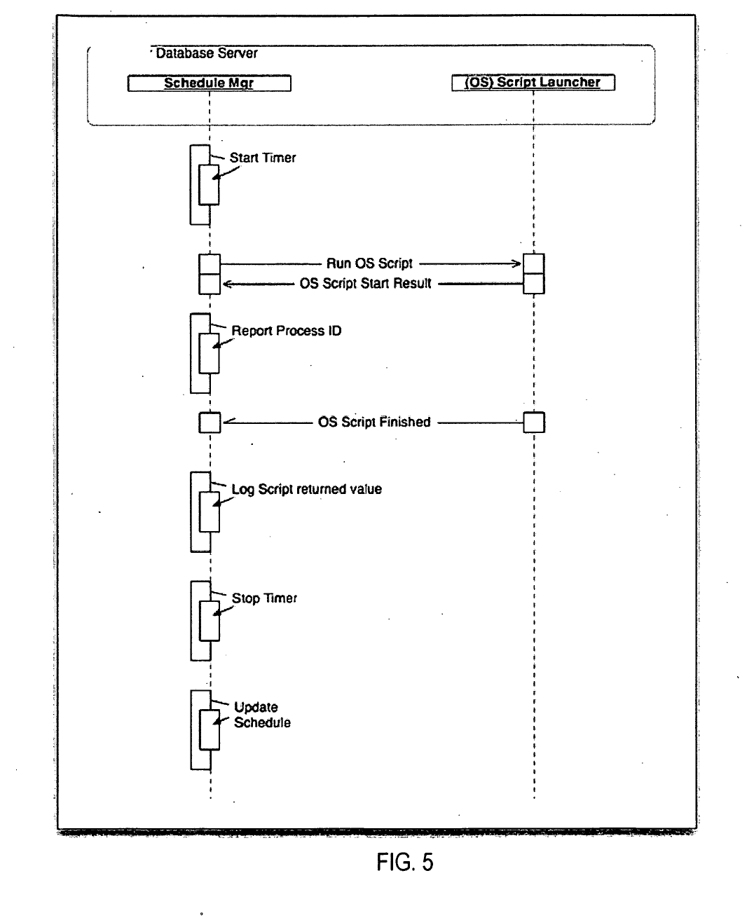

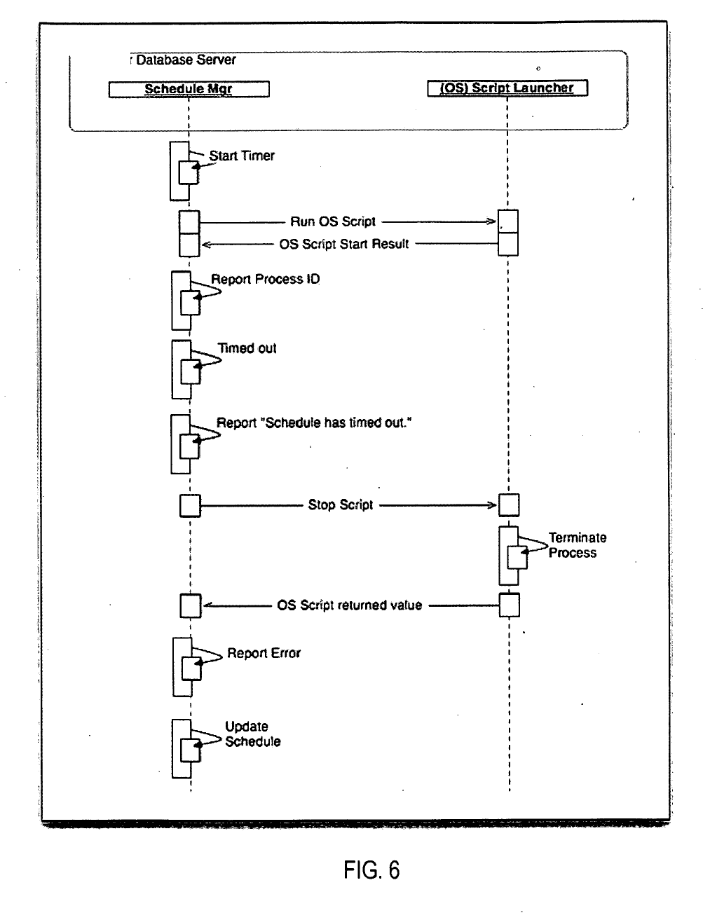

FIGS. 5 and 6 are sequence diagrams illustrating interaction between a schedule manager and a system script launcher. In some implementations, the schedule manager can reside in the database server and executes scheduled tasks. The system script launcher can reside in the database server. The database server creates a process, executes system scripts, monitors created processes and notifies the schedule manager when a script process is terminated.

Referring to FIG. 5, a best case scenario is shown. In this scenario, the interaction begins when a schedule manager starts a timer and sends a request to a system script launcher to run a system script. The system script launcher runs the system script and returns a start result, including a process ID. Responsive to receiving the start result, the schedule manager reports the process ID and waits for a return value from the system script launcher. When the return value is received by the schedule manager, the schedule manager logs the return value, stops the timer and updates the schedule.

Referring to FIG. 6, a scenario where the system script takes more time to execute than anticipated is shown. In this scenario, the interaction begins when the schedule manager starts a timer and sends a request to the system script launcher to run a system script. The system script launcher launches the system script and returns a start result, including a process ID. Upon receipt of the start result, the schedule manager reports the process ID.

In this scenario, the timer expires (e.g., exceeds the time limit specified by the administrator) before the system script completes. The schedule manager reports a “Schedule has timed out” or other suitable message. The schedule manager sends a stop script request to the system script launcher. Upon receipt of the stop script request, the system script launcher terminates the process and returns a script return value (e.g., an integer indicating an error) to the schedule manager. Upon receipt of the return value, the schedule manager reports the error and updates the schedule.

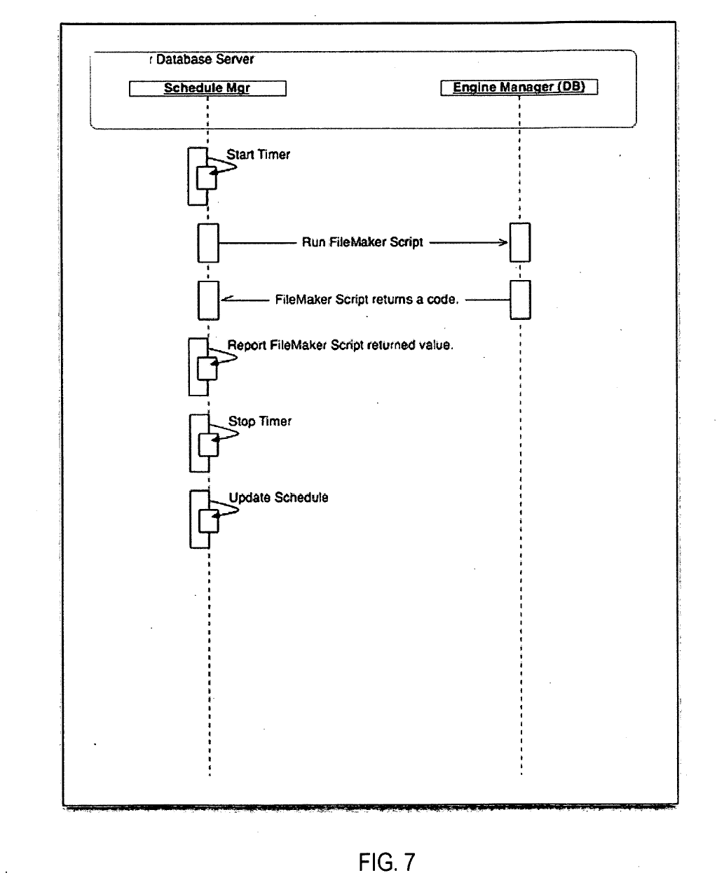

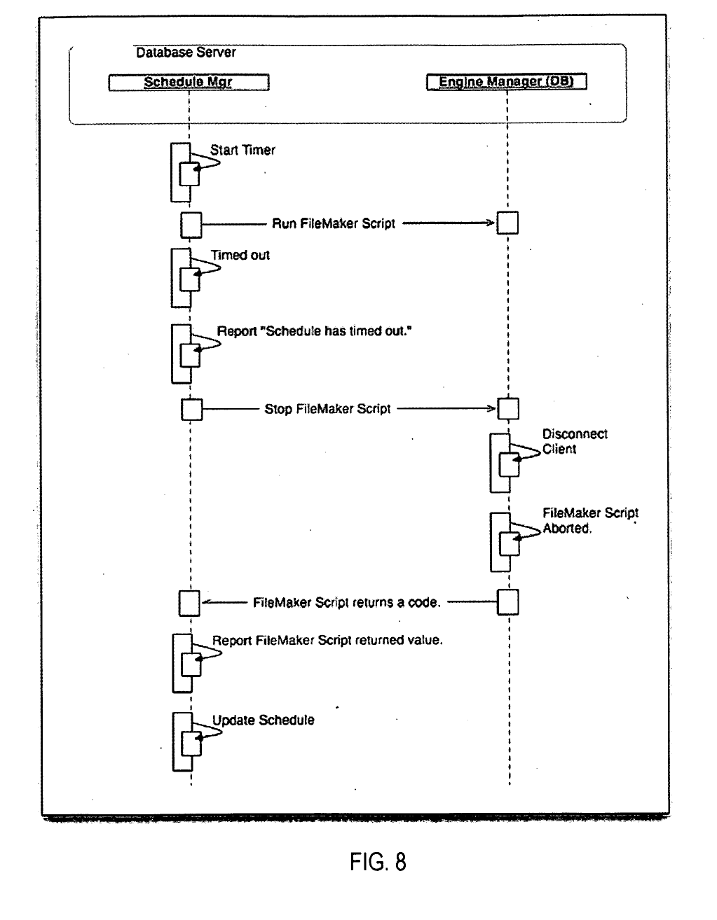

FIGS. 7 and 8 are sequence diagrams illustrating interaction between a schedule manager and a database engine manager. In some implementations, the database engine manager can reside in the database server process and can house and manage the database engine.

Referring to FIG. 7, a best case scenario is shown. In this scenario, the interaction begins when the schedule manager starts a timer and sends a request to the database engine manager to run a database script. The database engine manager runs the database script and returns a code. Upon receipt of the code, the schedule manager reports the database script returned value, stops the timer and updates the schedule.

Referring to FIG. 8, a scenario where the database script execution takes more time to execute than anticipated is shown. In this scenario, the interaction begins when the schedule manager starts a timer and sends a request to the database engine manager to run the database script. The database engine manager runs the script.

The timer expires before the script completes. The schedule manager reports a “Schedule has timed out” or other suitable message. The schedule manager sends a stop database script request to the database engine manager. Upon receipt of the stop request, the database engine manger disconnects the client, aborts the database script and sends a return code (e.g., indicating an error) to the schedule manager. Upon receipt of the return code, the schedule manager reports the returned value and updates the schedule.

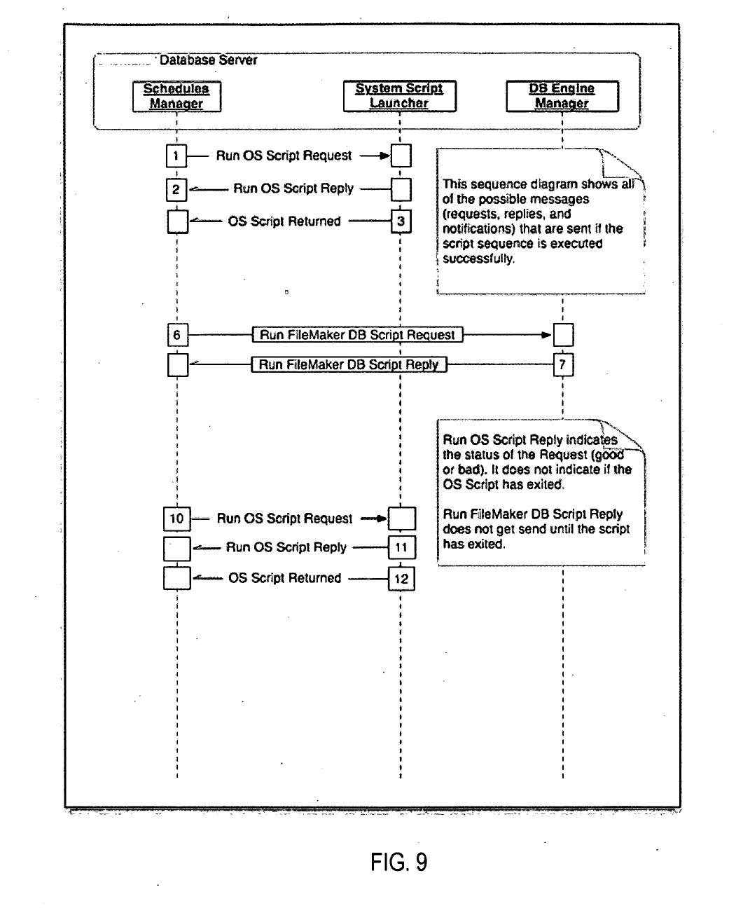

FIG. 9 is a sequence diagram illustrating interaction between a schedule manager, a system script launcher and a database engine manager. This sequence diagram shows some possible messages (e.g., requests, replies, notifications) that are sent by the various components of the script management system if the script sequence is executed successfully.

In this scenario, the interaction begins when the schedule manager sends a first request to the system script launcher to run a first system script. The system script launcher runs the first system script and sends a reply to the schedule manager indicating the status of the request (e.g., good or bad). Upon completion of the system script, the system script launcher returns the system script results.

When the first system script has exited, the schedule manager sends a request to the database engine manager to run a database script. The database engine manager runs the database script and sends a reply to the schedule manager that the database script is running. The reply indicates the status of the request (e.g., good or bad). The reply does not have to indicate if the system script was good or bad.

The schedule manager sends a second request to the system script launcher to run a second system script which can be the same or different than the first script. The system script launcher runs the second system script and sends a reply indicating the status of the request. The results of the system script are returned to the schedule manager.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
presenting a user interface;
obtaining first input specifying a script sequence, the script sequence including a database script and one or more system scripts;
obtaining second input specifying one or more sequence parameters associated with the script sequence, where at least one sequence parameter determines an order of execution of the database script and one or more system scripts; and
running the script sequence in accordance with the sequence parameter.

2. The method of claim 1, further comprising:
obtaining third input specifying a time limit to complete execution of the script sequence.

3. The method of claim 2, further comprising:
obtaining third input specifying that the script sequence is to be aborted if the time limit is reached.

4. The method of claim 2, where if the time limit is reached, the method further comprises:
aborting the script sequence; and
logging a warning for the aborted script sequence.

5. The method of claim 1, where the sequence parameter specifies that at least one system script will be run before the database script.

6. The method of claim 1, where the sequence parameter specifies that the database script will be run before a system script.

7. The method of claim 5, where running the script sequence further comprises:
running a first system script request;
obtaining a system script reply;
obtaining a system script return code or value;
determining if an error occurred while running the system script based on the return code or value; and
if no error has occurred, running a database script.

8. The method of claim 7, further comprising:
receiving a database script reply;
determining if an error occurred while running the database script based on the database script reply; and
if no error has occurred, running a second system script request.

9. A computer-readable medium having instructions stored thereon, which, when executed by a processor, causes the processor to perform operations comprising:
presenting a user interface;
obtaining first input specifying a script sequence, the script sequence including a database script and one or more system scripts;
obtaining second input specifying one or more sequence parameters associated with the script sequence, where at least one sequence parameter determines an order of execution of the database script and one or more system scripts; and
running the script sequence in accordance with the sequence parameter.

10. The computer-readable medium of claim 9, further comprising:
obtaining third input specifying a time limit to complete execution of the script sequence.

11. The computer-readable medium of claim 10, further comprising:
obtaining third input specifying that the script sequence is to be aborted if the time limit is reached.

12. The computer-readable medium of claim 10, where if the time limit is reached, the method further comprises:
aborting the script sequence; and
logging a warning for the aborted script sequence.

13. The computer-readable medium of claim 9, where the sequence parameter specifies that at least one system script will be run before the database script.

14. The computer-readable medium of claim 9, where the sequence parameter specifies that the database script will be run before a system script.

15. The computer-readable medium of claim 14, where running the script sequence further comprises:
running a first system script request;
obtaining a system script reply;
obtaining a system script return;
determining if an error occurred while running the system script based on the system script return; and
if no error has occurred, running a database script.

16. The computer-readable medium of claim 15, further comprising:
receiving a database script reply;
determining if an error occurred while running the database script based on the database script reply; and
if no error has occurred, running a second system script request.
